(19) United States
(12) Patent Application Publication
(10) Pub. No.: US 2019/0182345 A1
(43) Pub. Date: Jun. 13, 2019

(54) INFORMATION PUSHING METHOD AND SYSTEM FOR DISPLAY SCREEN OF REFRIGERATOR AND REFRIGERATOR HAVING THE SAME

(71) Applicants: HEFEI MIDEA INTELLIGENT TECHNOLOGIES CO., LTD., Hefei (CN); HEFEI HUALING CO., LTD., Hefei (CN); MIDEA GROUP CO., LTD., Foshan (CN)

(72) Inventors: Tao Ji, Hefei (CN); Yan Wang, Hefei (CN); Shiqing Yang, Hefei (CN); Hailei Chen, Hefei (CN)

(21) Appl. No.: 15/835,484

(22) Filed: Dec. 8, 2017

(51) Int. Cl. H04L 29/08; F25D 29/00

(52) U.S. Cl. CPC H04L 67/26; F25D 29/00; F25D 2700/00; F25D 2500/06; F25D 2400/361

(57) ABSTRACT

An information pushing method and system for a display screen of a refrigerator, and a refrigerator having the same are provided. The method includes: collecting ingredient information of the refrigerator; uploading the ingredient information to a server; analyzing by the server the ingredient information uploaded this time and historically uploaded ingredient information so as to acquire ingredient pushing information; transmitting the ingredient pushing information to the refrigerator and pushing the ingredient pushing information through the display screen of the refrigerator. In the method, the ingredient information of the refrigerator is collected and uploaded to the server, the ingredient information uploaded this time and historically uploaded ingredient information are analyzed so as to acquire the ingredient pushing information, such that the pushing information directed to the customer's needs can be provided and pushed through the display screen of the refrigerator with high pertinence and high user satisfaction.

### FIELD

The present disclosure relates to the field of household appliances, and more particularly to information pushing method and system for a display screen of a refrigerator, and a refrigerator having the same.

### BACKGROUND

With the development of electronic technology and reduction of related costs, a proportion of refrigerators with a screen in refrigerator products is increasing, and screen sizes are also growing larger and larger. In daily life, as working time of the refrigerator is the longest in domestic appliances, the refrigerator is most likely to acquire user-related big data, such as big data regarding use habits and ingredient preferences of a user.

However, there is no solution that combines a display screen of the refrigerator with information push in the related art. As the existing information pushing method for the domestic appliances is not based on a premise of acquiring the user-related big data, the information pushing method is not specific and has little effect.

### SUMMARY

Embodiments of the present disclosure seek to solve at least one of the problems existing in the related art to at least some extent.

Therefore, a first objective of the present disclosure is to provide an information pushing method for a display screen of a refrigerator. In the method, ingredient information of the refrigerator is collected and uploaded to a server, the ingredient information uploaded this time and historically uploaded ingredient information are analyzed so as to acquire ingredient pushing information, such that the pushing information directed to the customer's needs can be provided and pushed through the display screen of the refrigerator with high pertinence and high user satisfaction.

A second objective of the present disclosure is to provide an information pushing system for a display screen of a refrigerator.

A third objective of the present disclosure is to provide a refrigerator.

In order to realize the above objectives, an embodiment of a first aspect of the present disclosure provides an information pushing method for a display screen of a refrigerator, including: collecting ingredient information of the refrigerator; uploading the ingredient information to a server; analyzing by the server the ingredient information uploaded this time and historically uploaded ingredient information so as to acquire ingredient pushing information; transmitting the ingredient pushing information to the refrigerator and pushing the ingredient pushing information through the display screen of the refrigerator.

With the information pushing method for a display screen of a refrigerator provided in an embodiment of the present disclosure, the ingredient information of the refrigerator is collected and uploaded to the server, the ingredient information uploaded this time and historically uploaded ingredient information are analyzed so as to acquire the ingredient pushing information, such that the pushing information directed to the customer's needs can be provided and pushed through the display screen of the refrigerator with high pertinence and high user satisfaction.

In an embodiment of the present disclosure, the ingredient information is collected once every preset time or collected at a plurality of preset time points, and the ingredient pushing information is updated by the server according to the uploaded ingredient information.

In an embodiment of the present disclosure, the method further includes: storing by the refrigerator the ingredient pushing information; and pushing the ingredient pushing information through the display screen of the refrigerator includes: generating a pushing start signal when a user is detected to enter a preset area near the refrigerator or the refrigerator is operated; and pushing a latest ingredient pushing information according to the pushing start signal.

In an embodiment of the present disclosure, the ingredient pushing information includes video information and audio information.

In an embodiment of the present disclosure, pushing the latest ingredient pushing information according to the pushing start signal further includes: judging whether a time interval between receiving the pushing start signal this time and transmitting the ingredient pushing information last time is greater than a preset time interval, if yes, pushing the latest ingredient pushing information, and if no, not pushing the latest ingredient pushing information.

In order to realize the above objectives, an embodiment of a second aspect of the present disclosure provides an information pushing system for a display screen of a refrigerator, including: an ingredient information collecting module configured to collect ingredient information of the refrigerator; a refrigerator communicating module configured to upload the ingredient information; a server configured to receive the ingredient information, analyze the ingredient information uploaded this time and historically uploaded ingredient information so as to acquire ingredient pushing information, and transmit the ingredient pushing information to the refrigerator communicating module; an ingredient information pushing module disposed in the refrigerator and configured to push the ingredient pushing information.

With the information pushing system for a display screen of a refrigerator provided in an embodiment of the present disclosure, the ingredient information of the refrigerator is collected and uploaded to the server, the ingredient information uploaded this time and historically uploaded ingredient information are analyzed by the server so as to acquire ingredient pushing information, such that the pushing information directed to the customer's needs can be provided and pushed through the display screen of the refrigerator with high pertinence and high user satisfaction.

In an embodiment of the present disclosure, the ingredient information collecting module is configured to collect the ingredient information once every preset time or collect the ingredient information at a plurality of preset time points; and the server is configured to update the ingredient pushing information according to the uploaded ingredient information.

In an embodiment of the present disclosure, the system further includes a storing module disposed in the refrigerator and configured to store the ingredient pushing information transmitted by the server; a sensing module disposed in the refrigerator and configured to generate a pushing start signal when a user is detected to enter a preset area near the refrigerator or the refrigerator is operated, and the ingredient information pushing module is configured to push a latest ingredient pushing information according to the pushing start signal.

In an embodiment of the present disclosure, the system further includes a dormancy interval judging module connected with the sensing module and the ingredient information pushing module respectively, and configured to judge whether a time interval between receiving the pushing start signal this time and transmitting the ingredient pushing information last time is greater than a preset time interval, if yes, to control the ingredient information pushing module to push the latest ingredient pushing information, and if no, to control the ingredient information pushing module not to push the latest ingredient pushing information.

In order to realize the above objectives, an embodiment of a third aspect of the present disclosure provides a refrigerator including the information pushing system for a display screen of a refrigerator as described in the above embodiments.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart of an information pushing method for a display screen of a refrigerator according to an embodiment of the present disclosure; and

FIG. 2 is a block diagram of an information pushing system for a display screen of a refrigerator according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

The information pushing method and system for a display screen of a refrigerator, and the refrigerator according to embodiments of the present disclosure are described below with reference to the accompanying drawings.

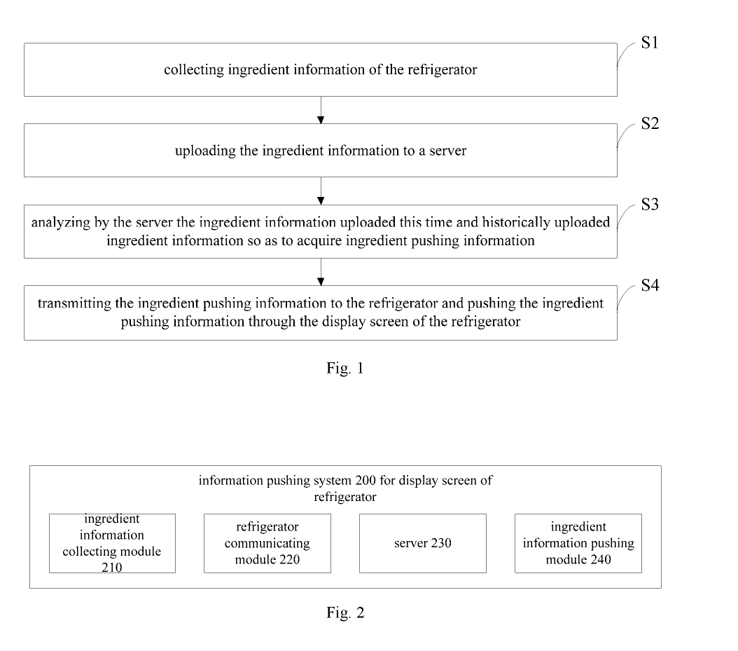

FIG. 1 is a flow chart of an information pushing method for a display screen of a refrigerator according to an embodiment of the present disclosure. As shown in FIG. 1, the information pushing method for a display screen of a refrigerator includes the following steps.

S1: ingredient information of the refrigerator is collected.

Specifically, the ingredient information of the refrigerator may be collected by an image collecting module disposed in the refrigerator. The ingredient information may include types, quantities/weights of the ingredients. Weight information may be acquired through a weighing module in the refrigerator. In an embodiment of the present disclosure, the weighing module is disposed on a support frame of the refrigerator, and the support frame at each layer is only used for placing the same ingredient, e.g., only eggs are placed on the support frame at a first layer. The weight of the eggs in the refrigerator may be acquired by the weighing module on the support frame at the first layer.

S2: the ingredient information is uploaded to a server.

Specifically, the refrigerator is provided with a communicating module, and the communicating module receives the ingredient information and uploads the ingredient information to the server.

In an embodiment of the present disclosure, the ingredient information is collected once every preset time or collected at a plurality of preset time points.

Specifically, a manner of collecting the ingredient information of the refrigerator may be set by a user or set by a manufacturer. As a manner of collecting the ingredient information of the refrigerator, the refrigerator may be set to collect automatically the ingredient information therein once every 8 hours, which is mainly for such a case that capacity of the refrigerator is large and the ingredient of the refrigerator are frequently placed in or taken off. For example, a volume of the refrigerator is over 200 L, and the refrigerator is used at different time by family members due to their different meal time. In addition, another manner of collecting the ingredient information of the refrigerator may be that the ingredient information of the refrigerator is collected at a plurality of preset time points. For example, the ingredient information of the refrigerator may be collected at a certain time point after the user has cooked each time. In an embodiment of the present disclosure, the ingredient information of the refrigerator is collected at 9:00, 14:00 and 21:00 in each day.

S3: the ingredient information uploaded this time and historically uploaded ingredient information are analyzed by the server so as to acquire ingredient pushing information.

Specifically, the server may know the user's dietary preference according to the ingredient information uploaded by the user, so as to obtain the ingredient pushing information for the missing ingredient according to above ingredient information. The ingredient pushing information may include one or more of ingredient types, quantities/weights of the ingredients, discount information of a nearby supermarket/mall/online shop.

S4: the ingredient pushing information is transmitted by the server to the refrigerator and is pushed through the display screen of the refrigerator.

Specifically, the server updates the ingredient pushing information according to the ingredient information uploaded by the user each time, and transmits the ingredient pushing information to the refrigerator for pushing.

In an embodiment of the present disclosure, step S4 includes the following steps.

S401: a pushing start signal is generated when the user is detected to enter a preset area near the refrigerator or the refrigerator is operated.

Specifically, the pushing start signal is generated when the user is detected by a distance sensing module to enter the preset area near the refrigerator from a position away from the preset area of the refrigerator. In an embodiment of the present disclosure, the preset distance is 1 m, it can be set that the ingredient pushing information is pushed when the user enters an area near the refrigerator by 1 m. As another manner, the pushing start signal is generated only when the user touches the refrigerator.

S402: a latest ingredient pushing information is pushed according to the pushing start signal.

Specifically, if the manner that the ingredient pushing information is pushed when the user enters the preset area near the refrigerator is used, electric energy can be saved, and repugnance from the user caused by displaying the pushed information for a long time can be avoided. The ingredient pushing information may be a picture or a short video, and time of the ingredient pushing information may be set and adjustable. If the manner that the ingredient pushing information is pushed when the user touches the refrigerator is used, the ingredient pushing information should include audio information, because the user may not pay attention to the picture or video information on the screen when the user opens a door of the refrigerator. Further, a volume of the audio information is preset and adjustable. For example, on non-public holidays, the volume before 7:00 a.m. and after 10:00 p.m. is lower than a standard value, and the volume at rest of the time period is the standard value. By setting different volumes at different time periods, it can be avoided that the ingredient pushing information is suddenly pushed in a quiet environment to disturb the rest of other people or the user is scared by the sudden loud sounds.

In an embodiment of the present disclosure, step S402 further includes: judging whether a time interval between receiving the pushing start signal this time and transmitting the ingredient pushing information last time is greater than a preset time interval, if yes, pushing the latest ingredient pushing information, and if no, not pushing the latest ingredient pushing information. By setting the preset time interval between two pushes, repugnance from the user resentment caused by frequently information pushing is avoided, and the energy is saved.

FIG. 2 is a block diagram of an information pushing system for a display screen of a refrigerator according to an embodiment of the present disclosure. Referring to FIG. 2, the information pushing system 200 for a display screen of a refrigerator includes an ingredient information collecting module 210, a refrigerator communicating module 220, a server 230, and an ingredient information pushing module 240.

The ingredient information collecting module 210 is configured to collect ingredient information of the refrigerator. The refrigerator communicating module 220 is configured to upload the ingredient information. The server 230 is configured to receive the ingredient information, analyze the ingredient information uploaded this time and historically uploaded ingredient information so as to acquire ingredient pushing information, and transmit the ingredient pushing information to the refrigerator communicating module 220. The ingredient information pushing module 240 is disposed in the refrigerator and configured to push the ingredient pushing information.

In an embodiment of the present disclosure, the ingredient information collecting module 210 is configured to collect the ingredient information once every preset time or collect the ingredient information at a plurality of preset time points. The server 230 is configured to update the ingredient pushing information according to the uploaded ingredient information.

In an embodiment of the present disclosure, the information pushing system 200 for a display screen of a refrigerator further includes a storing module 250 and a sensing module 260. The storing module 250 is disposed in the refrigerator and configured to store the ingredient pushing information transmitted by the server 230. The sensing module 260 is disposed in the refrigerator and configured to generate a pushing start signal when a user is detected to enter a preset area near the refrigerator or the refrigerator is operated. A latest ingredient pushing information is pushed by the ingredient information pushing module 240 according to the pushing start signal.

In an embodiment of the present disclosure, the information pushing system for a display of a refrigerator further includes a dormancy interval judging module 270 connected with the sensing module 260 and the ingredient information pushing module 240 respectively, and configured to judge whether a time interval between receiving the pushing start signal this time and transmitting the ingredient pushing information last time is greater than a preset time interval, if yes, to control the ingredient information pushing module to push the latest ingredient pushing information, and if no, to control the ingredient information pushing module not to push the latest ingredient pushing information.

It should be noted that, the specific implementation manner of the information pushing system for a display screen of a refrigerator is similar to the specific implementation manner of the information pushing method for a display screen of a refrigerator described in detail in the method part, which will not be elaborated herein.

Further, in an embodiment of the present disclosure, a refrigerator is disclosed, which is provided with the information pushing system for a display screen of a refrigerator as described in any one of the above embodiments.

In addition, other configurations and functions of the refrigerator according to embodiments of the present disclosure are known to those skilled in the art, which will not be elaborated herein.

In the specification, it is to be understood that terms such as “central,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise” “axial,” “radial,” and “circumferential” should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance or to imply the number of indicated technical features. Thus, the feature defined with “first” and “second” may include one or more of this feature. In the description of the present disclosure, the phrase of “a plurality of” means two or more than two, for example, two or three, unless specified otherwise.

In the present disclosure, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements, which may be understood by those skilled in the art according to specific situations.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. In addition, in the absence of contradiction, those skilled in the art can combine the different embodiments or examples described in this specification, or combine the features of different embodiments or examples.

Although explanatory embodiments have been shown and described, it would be appreciated by those skilled in the art that the above embodiments cannot be construed to limit the present disclosure, and changes, alternatives, and modifications may be made in the embodiments without departing from spirit, principles and scope of the present disclosure.

What is claimed is:

1. An information pushing method for a display screen of a refrigerator, comprising:
collecting ingredient information of the refrigerator;
uploading the ingredient information to a server;
analyzing by the server the ingredient information uploaded this time and historically uploaded ingredient information so as to acquire ingredient pushing information;
transmitting the ingredient pushing information to the refrigerator and pushing the ingredient pushing information through the display screen of the refrigerator.

2. The method according to claim 1, wherein the ingredient information is collected once every preset time or collected at a plurality of preset time points, and the ingredient pushing information is updated by the server according to the uploaded ingredient information.

3. The method according to claim 2, further comprising:
storing by the refrigerator the ingredient pushing information; and
wherein pushing the ingredient pushing information through the display screen of the refrigerator comprises:
generating a pushing start signal when a user is detected to enter a preset area near the refrigerator or the refrigerator is operated; and
pushing a latest ingredient pushing information according to the pushing start signal.

4. The method according to claim 1, wherein the ingredient pushing information comprises video information and audio information.

5. The method according to claim 3, wherein pushing the latest ingredient pushing information according to the pushing start signal further comprises:
judging whether a time interval between receiving the pushing start signal this time and transmitting the ingredient pushing information last time is greater than a preset time interval, if yes, pushing the latest ingredient pushing information, and if no, not pushing the latest ingredient pushing information.

6. An information pushing system for a display screen of a refrigerator, comprising:
an ingredient information collecting module configured to collect ingredient information of the refrigerator;
a refrigerator communicating module configured to upload the ingredient information;
a server configured to receive the ingredient information, analyze the ingredient information uploaded this time and historically uploaded ingredient information so as to acquire ingredient pushing information, and transmit the ingredient pushing information to the refrigerator communicating module;
an ingredient information pushing module disposed in the refrigerator and configured to push the ingredient pushing information.

7. The system according to claim 6, wherein the ingredient information collecting module is configured to collect the ingredient information once every preset time or collect the ingredient information at a plurality of preset time points; and the server is configured to update the ingredient pushing information according to the uploaded ingredient information.

8. The system according to claim 7, further comprising:
a storing module disposed in the refrigerator and configured to store the ingredient pushing information transmitted by the server;
a sensing module disposed in the refrigerator and configured to generate a pushing start signal when a user is detected to enter a preset area near the refrigerator or the refrigerator is operated,
wherein the ingredient information pushing module is configured to push a latest ingredient pushing information according to the pushing start signal.

9. The system according to claim 8, further comprising:
a dormancy interval judging module connected with the sensing module and the ingredient information pushing module respectively, and configured to judge whether a time interval between receiving the pushing start signal this time and transmitting the ingredient pushing information last time is greater than a preset time interval, if yes, to control the ingredient information pushing module to push the latest ingredient pushing information, and if no, to control the ingredient information pushing module not to push the latest ingredient pushing information.

10. A refrigerator, comprising an information pushing system for a display screen of a refrigerator, comprising:
an ingredient information collecting module configured to collect ingredient information of the refrigerator;
a refrigerator communicating module configured to upload the ingredient information;
a server configured to receive the ingredient information, analyze the ingredient information uploaded this time and historically uploaded ingredient information so as to acquire ingredient pushing information, and transmit the ingredient pushing information to the refrigerator communicating module;
an ingredient information pushing module disposed in the refrigerator and configured to push the ingredient pushing information.
